(19) United States
(12) Patent Application Publication
(10) Pub. No.: US 2013/0303118 A1
(43) Pub. Date: Nov. 14, 2013

(54) MOBILE DEVICE SECURITY

(71) Applicant: T-MOBILE USA, INC., Bellevue, WA (US)

(72) Inventors: Cristian ASANDULUI, Snoqualmie, WA (US); Jonathan SOINI, Seattle, WA (US); Tyler AXDORFF, Seattle, WA (US)

(73) Assignee: T-MOBILE USA, INC., Bellevue, WA (US)

(21) Appl. No.: 13/837,368

(22) Filed: Mar. 15, 2013

Related U.S. Application Data
(60) Provisional application No. 61/646,112, filed on May 11, 2012.
(60) Provisional application No. 61/705,020, filed on Sep. 24, 2012.

(51) Int. Cl. H04W 12/10

(52) U.S. Cl. CPC H04W 12/10
USPC 455/410

(57) ABSTRACT

Systems, methods and procedures are described for thwarting undesirable applications from affecting mobile communication devices. A mobile communication device uses a server to assist in identifying and removing undesirable applications.

### RELATED APPLICATIONS

This Application claims priority benefit of Provisional Application No. 61/646,112, which was filed on May 11, 2012. Furthermore, this Application claims priority benefit of Provisional Application No. 61/705,020, which was filed on Sep. 24, 2012. The entire contents of the indicated Provisional Applications are hereby incorporated herein by reference.

### BACKGROUND

Mobile communication devices have become increasingly popular. With the increasing popularity, manufacturers of mobile communication devices have enhanced the functionality associated with such communication devices. For example, many modern mobile communication devices, such as smartphones, are capable of storing and executing many different applications. These different applications may include: mapping applications, adult and children's game applications, productivity applications, and the like.

A mobile communication device user often has the freedom to choose and install different applications, thereby customizing the mobile communication device experience. However, while there are many positive applications available on the market, the ability to interact, install, and operate third party applications inevitably leaves the mobile communication device susceptible to vulnerabilities, malware, and other harmful applications.

It is difficult to safeguard mobile communication devices fully at the mobile network level, as devices may connect to additional networks and utilize encrypted services, both of which often bypass network level protection. In addition, it is difficult to protect mobile communication devices from undesirable applications because many different types of data and applications are available for such devices. Furthermore, mobile communication devices generally do not have the processing and/or storage capability to run conventional antivirus and malware applications that protect against dangers associated with malicious applications. Furthermore, it is difficult to identify new, previously unknown malicious applications by their behavior and to track and prevent the spread or dissemination of damaging applications and data once they have been released to the network.

### BRIEF DESCRIPTION OF THE DRAWINGS

The detailed description is forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure.

FIG. 1 illustrates components of a mobile device, according to an exemplary implementation.

FIG. 2 is an illustrative computing device that may be used to implement exemplary implementations described herein.

FIG. 3 is a flow diagram illustrating an example process for providing a mobile communication device security according to an implementation.

### DETAILED DESCRIPTION

Systems, methods and procedures are described for thwarting undesirable applications from affecting mobile communication devices. A mobile communication device uses a server to assist in identifying and removing undesirable applications.

Wireless communication device, mobile communication device or user device, as used herein and throughout this disclosure, refers to any electronic device capable of wirelessly sending and receiving data. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

Mobile devices may communicate with each other and with other elements via a network, for instance, a wireless network, or a wireline network. A network may include broadband wide-area networks such as cellular networks, local-area networks (LAN), Wi-Fi, and personal area networks, such as NFC networks including Bluetooth®. Communication across a network may be packet-based; however, radio and frequency/amplitude modulation networks may enable communication between communication devices using appropriate analog-digital-analog converters and other elements. Communication may be enabled by hardware or mixed hardware and software elements called transceivers. Mobile devices may have more than one transceiver, capable of communicating over different networks. For example, a cellular telephone may include a cellular transceiver for communicating with a cellular base station, a Wi-Fi transceiver for communicating with a Wi-Fi network, and a Bluetooth® transceiver for communicating with a Bluetooth® device. A Wi-Fi network is accessible via access points such as wireless routers, etc., that communicate with the Wi-Fi transceiver to send and receive data. The Wi-Fi network may further be connected to the internet or other packet-based networks. The bandwidth of a network connection or an access point is a measure of the rate of data transfer, and can be expressed as a quantity of data transferred per unit of time.

A network typically includes a plurality of elements that host logic or intelligence for performing tasks on the network. The logic can be hosted on servers. In modern packet-based wide-area networks, servers may be placed at several logical points on the network. Servers may further be in communication with databases and can enable communication devices to access the contents of a database. Billing servers, application servers, etc. are examples of such servers. A server may include several network elements, including other servers, and can be logically situation anywhere on a service provider's network, such as the back-end of a cellular network. A server hosts or is in communication with a database hosting an account for a user of a mobile device. The user account includes several attributes for a particular user, including a unique identifier of the mobile device(s) owned by the user, relationships with other users, application usage, location, personal settings, business rules, bank accounts, and other information. A server may communicate with other servers on different networks to update a user account.

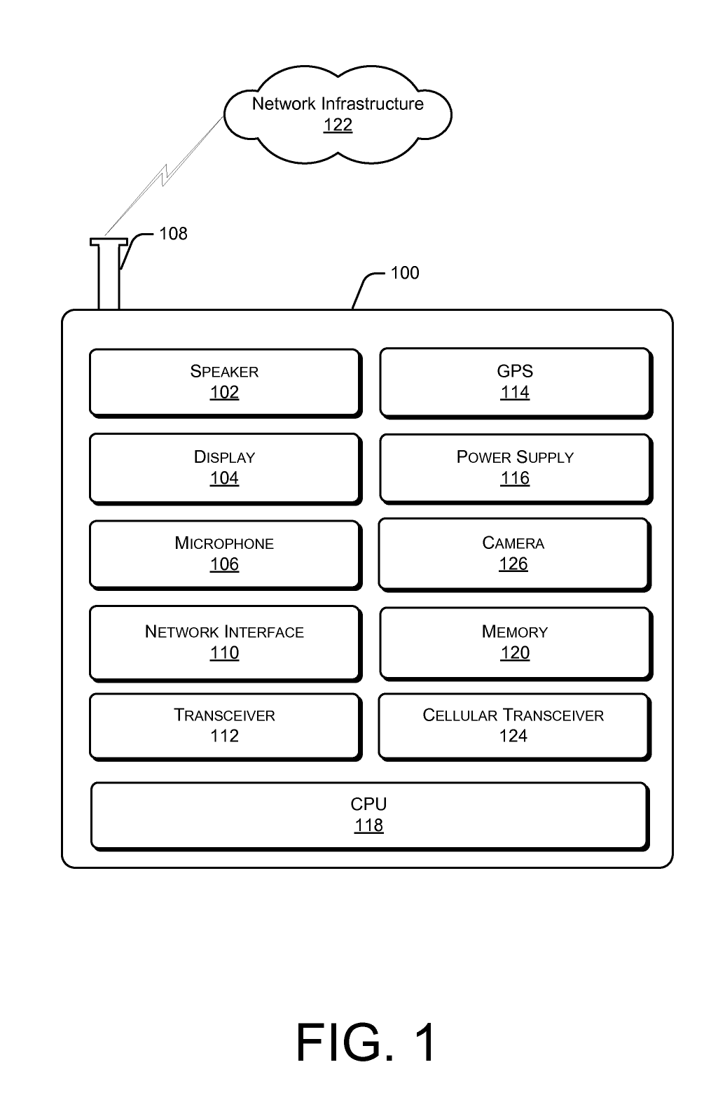

FIG. 1 illustrates components of a mobile communication device 100, according to an exemplary embodiment. The mobile device 100 may include a speaker 102, a display 104, a microphone 106, and an antenna 108. The mobile device 100 may further include a network interface 110, a transceiver 112, a Global Positioning System (GPS) receiver 114, a power supply 116, a central processing unit (CPU) 118, and a memory 120. Furthermore, the mobile device 100 may include a cellular transceiver 124 and a camera 126. The camera 126, or what may be referred to as a general image capturing device, may capture images, obtain images from video captured by the camera 126, and capture video.

The transceiver 112 may provide NFC functionality. NFC is a short-range wireless connectivity technology that may provide digital communication between devices by touching them together or placing them within a close proximity to each other (e.g., approximately two inches). NFC technology may be incorporated into stand-alone, discrete devices, or on the other hand may be incorporated into existing devices, which may be referred to as NFC communications enabled devices. For example, devices that do not have built-in NFC technology may be outfitted with an NFC sleeve, which provides NFC functionality. The transceiver 112 may also provide other wireless communication functionality. For example, the transceiver 112 may be enabled to provide Bluetooth and/or Wi-Fi communication capabilities. Furthermore, the transceiver 112 may be capable of interfacing with an NFC sleeve that is coupled to the mobile device 100.

The speaker 102 provides an audio output for the mobile device 100. The display 104 may be an LCD or LED or other type of display on which a user can view selections, images, video, numbers, letters, etc. The display 104 may also be a touchscreen, thereby being used as an input device. In embodiments not using a touchscreen, a keypad is typically used as an input device, for instance, to type a phone number or a message. Such a keypad may be a numerical keypad, a QWERTY keyboard, etc. The microphone 106 allows the user to verbally communicate with others using mobile device 100. The antenna 108 is a transducer designed to transmit or receive electromagnetic waves to and from a network 122. In conjunction with the antenna 108, the network interface 110 allows the mobile device 100 to wirelessly communicate with network 122, such as a cellular network and/or an access point, or with other wireless devices across the network 122. The network 122 may include, but is not limited as such, operator equipment necessary to enable mobile devices to communicate using cellular communication technology and protocols. Furthermore, the network 122 may include servers, servers that include databases, one or more processors that execute instructions stored in memory and/or storage, and the like. Furthermore, the network 122 may include mobile devices similar to the mobile device 100. Therefore, the mobile device 100 may be in direct or indirect communication with one or more such mobile devices included in the network 122.

The network interface 110 may be a cellular transceiver, wireless transceiver, etc., and may include combinations of transceivers to communicate with assorted wireless networks. Alternatively, the network interface 110 may couple one or more transceivers of the mobile device 100 to one or more communication networks. The transceiver 112 enables mobile device 100 to wirelessly communicate over short ranges with a Wi-Fi access point and NFC devices, and through the access point, to a packet-based network such as the Internet, and other devices on the internet. The GPS transceiver 114 enables a determination of a location of mobile device 100, by receiving signals from a GPS satellite. In addition to these signals, network interface 110 can receive assistance data from an A-GPS server on the cellular network, thereby enabling GPS receiver 114 to get a faster fix on a satellite signal. The power supply 116 provides power to each of the components of mobile device 100, and can include a battery, as well as an interface to an external power supply. The CPU 118 controls components of mobile device 100 according to instructions stored in the memory 120.

The memory 120 may be any computer readable medium, such as RAM, ROM, etc. The memory 120 may store intelligence, such as computer readable instructions, in addition to logic for operating the components of mobile device 100. The memory 120 further may store a database or have logically known assessable memory locations including media, such as images, video, files, and the like. The media stored in the memory 120 may have been captured by the camera 126.

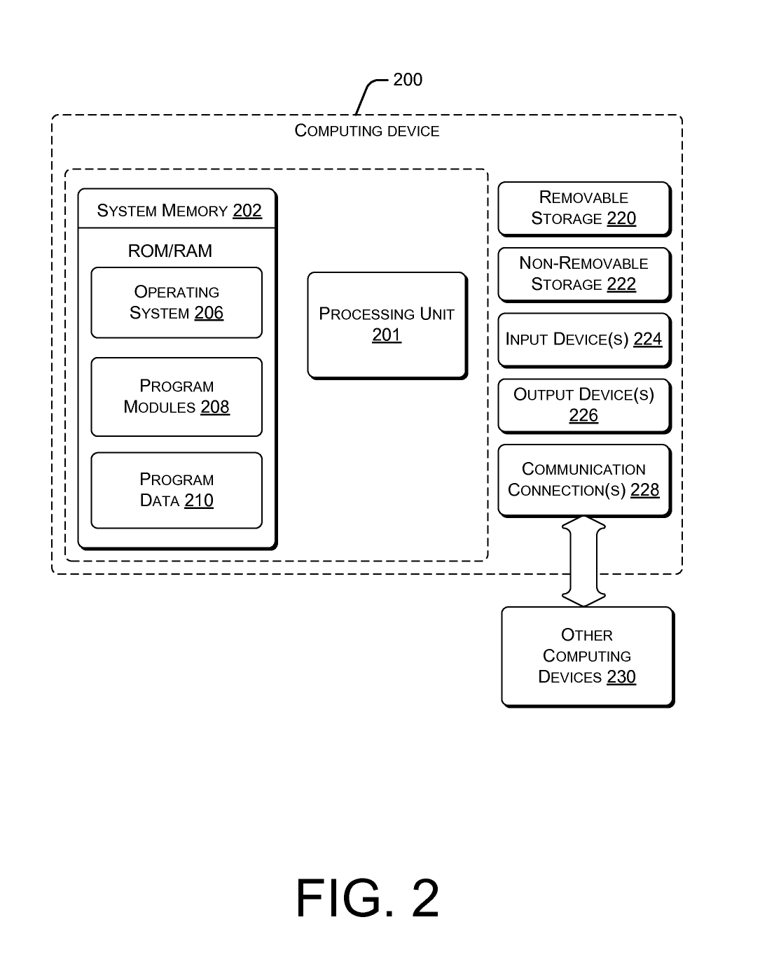

FIG. 2 is an illustrative computing device 200 that may be used to implement exemplary implementations described herein. For example, one or more computing devices 200 may be associated with the network infrastructure. In a very basic configuration, the computing device 200 includes at least one processing unit 201 and a system memory 202. Depending on the exact configuration and type of the computing device 200, the system memory 202 may be volatile (such as RAM), non-volatile (such as ROM, flash memory, etc.) or some combination of the two. The system memory 202 typically includes an operating system 206, one or more program modules or applications 208, and may include program data 210 in the form of, in one implementation, executable instructions.

The computing device 200 may have additional features or functionality. For example, the computing device 200 may also include additional data storage devices (removable and/or non-removable) such as, for example, magnetic disks, optical disks, or tape. Such additional storage is illustrated in FIG. 2 by a removable storage 220 and a non-removable storage 222. Computer storage media may include volatile and nonvolatile, removable and non-removable media implemented in any method or technology for storage of information, such as computer readable instructions, data structures, program modules, or other data. The system memory 202, removable storage 220 and the non-removable storage 222 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 200. Any such computer storage media may be part of the device 200. The computing device 200 may also have an input device(s) 224 such as keyboard, mouse, pen, voice input device, touch input device, etc. An output device(s) 226 such as a display, speakers, printer, etc. may also be included. These devices are well know in the art and need not be discussed at length.

The computing device 200 may also contain a communication connection to an and 28 that allow the device to communicate with other computing devices 230, such as over a wireless or wireline network (e.g. the Internet). The communication connection(s) 228 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media can be any available media that can be accessed by a computer. By way of example, and not limitation, computer readable media may comprise “computer storage media” and “communications media.”

In order to provide security services for the mobile communication device 100, one having ordinary skill in the art will appreciate that mobile communication device 100 may transmit certain data the network infrastructure 122, such as a server associated with the network infrastructure 122. As will be discussed in more detail below, the network infrastructure 122 may analyze this data and provide a security related determination, response and/or other action. The following describes the type(s) of data transmitted from the mobile communication device 100 to the network infrastructure 122, the analysis performed by the network infrastructure 122, and the action taken with or by the mobile communication device 100.

This disclosure contemplates that data may be used to evaluate and protect mobile communication devices. Such data may be related to a particular application, file, or object that may be installed or run on a mobile communication device. As used herein, this data may be referred to as application data. Application data may include both data associated with an application and information about such data, such as behavioral data or metadata. Data objects may include application packages that may be particular to certain mobile communication devices. For example, application packages may include IPA files or APP packages, or APK files, or CAB, EXE or DLL files.

Application data may include data that are malware or spyware, and thereby can negatively affect a mobile communication device. Malware and spyware may include applications, files, and other data that are purposefully designed to adversely affect or steal information from a mobile communication device. Furthermore, a data object associated with an application may be undesirable because it compromises privacy, overtaxes a device's battery or network connection, and/or has objectionable content.

Application data may include metadata about applications. For example, metadata may be information about a specific application. Metadata may include the location on a mobile communication device's filesystem where a an application is stored. Metadata for a data object may also include from where the application came (e.g., a URL from where it was downloaded, an application marketplace from which it was downloaded, a memory card from where it was installed or stored. Metadata may also be retrieved from an application marketplace. Such metadata, called marketplace metadata, includes information about an application such as the number of downloads, user comments about the application, the description of the application, permissions requested by the application, hardware or software requirements for the application, information about the application's author, the price of the application, the language or languages supported by the application, and other information that a marketplace may provide.

In an embodiment, application data may also include behavioral data. Behavioral data may include information about how an application interacts with or uses a mobile communication device's resources, such as memory usage, battery usage, network usage, storage usage, CPU usages, API usage, errors and crashes, and network services connected to (e.g., remote host address and port). Behavioral data may also include information about how an application, file or data object, when it is run, utilizes the functionalities of the mobile communication device's operating system, such as notifications and messaging between processes or installed applications.

As will be explained further below, both device data and application data are useful for providing an determination of the security of a device based upon the data stored (e.g., installed applications) or passing through the device. One having ordinary skill in the art will appreciate that device data and application data are merely examples of the types of data that may used in order to safeguard a mobile communication device or provide other functions related to a mobile communication device.

As used herein, the term determination refers to information relating to an application that may be used to evaluate or otherwise further understand the application's operation or effect of operation. For example, a determination may include a determination that an application is malicious or non-malicious, bad or good, unsafe or safe, or that an application may appear on a blacklist or whitelist. The determination may include categorization or characterization data for a data object, ratings such as security ratings, privacy ratings, performance ratings, quality ratings, and battery impact ratings for a data object, trust ratings for a data object, distribution data for a data object. Determinations may result from collecting and/or processing data by the network infrastructure 122 and may be exposed by the network infrastructure 122 to users or other systems via an API, user interfaces, data feeds, or other methods.

The following discussion relates to communications between the network infrastructure 122 and the mobile communication device 100 over network 121. Any data transmitted or received during these communications may be stored on the network infrastructure 122 or on data storage 111. In an embodiment, some or all of the data is stored on the network infrastructure 122 or data storage 111 with an anonymous association to a particular account or device. For example, data may be stored with an anonymous association for privacy purposes so that examination of the data on the network infrastructure 122 or data store 111 cannot tie the anonymously-associated data to a particular account or device; however, a device can populate and update this anonymously-associated data.

In an embodiment, the network infrastructure 122 may request information from the mobile communication device 100, which may respond with the requested information. In an embodiment, a mobile communication device 101 may transmit device data and/or application data to the network infrastructure 122 for analysis and determination. For example, a user of mobile communication device 101 may wish to download an application to his device, but prior to installing the application, may wish to send the application or identifying data associated with the application to the network infrastructure 122 in order to check if the file is malicious or otherwise undesirable. The network infrastructure 122 may then analyze this received information in order to provide a security determination to the mobile communication device 100. In another example, it may be useful to know how an assessed application will affect the performance or behavior of the mobile communication device 100, the determination containing information such as average battery impact or average network usage of the application. In an embodiment, the network infrastructure 122 may determinations of applications after analysis and can provide access to these determinations in a number of ways.

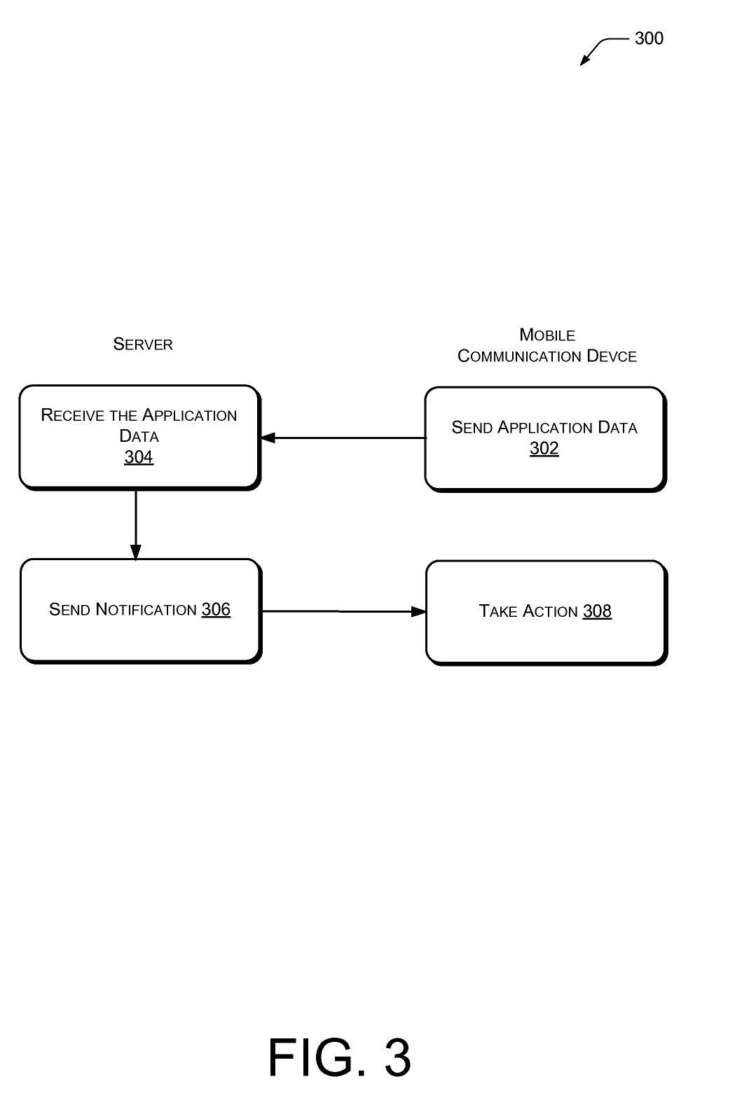

FIG. 3 is a flow diagram illustrating an example process for providing a mobile communication device security according to an implementation. The process 300 may reference elements illustrated in FIGS. 1-2. However, generally, the disclosed process 300 may be implemented by a device, a system of devices, computer-readable medium including computer-executable instructions that, when executed, perform the process 300, and the like. The process 300 may be executed by a mobile communication device, such as device 100 and/or by one or more servers associated with the network infrastructure 122. Moreover, the process may be executed by a general computing device.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable materials, or combinations thereof, without departing from the scope of the subject matter described herein.

As FIG. 3 shows, in block 302, a mobile communication device sends application data to a server. At block 304, the server receives the application data. In this embodiment, the mobile communication device may send identifying or authentication information to the server so that server can reference previously stored identifying or authentication information about the mobile communication device, store and retrieve data associated with the mobile communication device, and specifically identify or authenticate mobile communication device amongst other mobile communication devices.

In an embodiment, at block 306, the server sends a notification to mobile communication device. This notification can be an alert, a message, an instruction or other information related to application data or device data specific to mobile communication device. In an embodiment, the notification is due to a mobile device previously having sent application data corresponding to an application that was not initially assessed by the server to be undesirable but was subsequently determined by the server to be undesirable. At block 308, the mobile communication device receives the notification, and the mobile communication device may take action based upon the notification. For example, the mobile communication device may deactivate one or more features or applications on the mobile communication device.

One having skill in the art will appreciate that the interaction between the mobile communication device and the server may include communication from the mobile communication device to the server, as well as from the server to the mobile communication device. For example, in an embodiment, the server may receive application data from mobile communication device, but the server may require additional information before providing a determination or transmitting a notification. Furthermore, the server may request the additional information from the mobile communication device. The mobile communication device may receive the request, gather additional information as requested by the server, then transmit the additional information to the server. One will appreciate that this process may repeat as necessary. Furthermore, one having skill in the art will appreciate that the mobile device may execute, alone, at least each of the acts illustrated in the process 300.

In an example using at least one or more acts of the process 300, a security system installed on the mobile communication device 100 may report data associated with an application to the server for purposes of receiving a determination of the data associated with the application. If a mobile communication device downloads a new application that is malicious, it is important that the security system detect this new item as soon as possible. The server may analyze the new application and provide a security determination whereby actions can be taken based on the results. In another example, a first version of an application may be safe, but a second version of the application may be malicious. It is important that a security system recognize this update as different from the first version of the application so that it will produce a new determination of the second version and not just report the first determination. The server can analyze the updated application and provide a security determination whereby actions can be taken based on the results.

In an embodiment, using at least the process 300, the server may gather application information from multiple mobile communication devices. For example, to characterize an application's usage of SMS messaging to determine whether or not it is abusing SMS messaging, for example for spam purposes, the server may request the count of SMS messages sent by an application from one or more mobile communication devices that have previously reported that they have installed the application. The server may send a notification to one or more mobile communication devices using the application if it is determined that SMS messaging is being by an application.

In an embodiment, using at least the process 300, the application information associated with an application, gathered and transmitted by mobile communication device to server may include behavioral data about the application. The behavioral data may include information about what the application did when it ran on the mobile communication device. Examples of behavioral data include information about network connections caused by the application (e.g., server names, source/destination addresses and ports, duration of connection, connection protocols, amount of data transmitted and received, total number of connections, frequency of connections, and network interface information for the connection, DNS requests made), behavior of the application when run (e.g., system calls, API calls, libraries used, inter-process communication calls, number of SMS messages transmitted, use of contacts stored on the mobile communication device, use of other private information associated with the mobile communication device, use of positioning information associated with the mobile communication device, number of email messages sent, information about user interfaces displayed, URLs accessed), overhead caused by the application (e.g., battery used, CPU time used, network data transmitted, storage used, memory used). Other behavioral data includes the context when a particular behavior occurred (e.g., whether the phone's screen was off when the data object sent an SMS message, whether the user was using the application when it connected to a remote server, etc.). The server may send a notification to one or more mobile communication devices using the application if it is determined that the behavior data is deemed to be out of the ordinary for a particular application.

In an embodiment, using the process 300, a mobile communication device may only transmit behavioral data associated with an application if the data is outside what may be considered normal operational characteristics for the application. For example, it may be considered an out of the ordinary operational characteristic if the application maintains at least one open connection for more than 50% of the time it is running or if the application transmits more than one megabyte of data in a 24 hour period. In an embodiment, operational characteristics may be particular to one or more applications. In another example it may be considered an out of the ordinary operational characteristic if the application is using SMS capabilities, email capabilities, private information, contacts associated with the mobile communication device, and the like, in a manner that is recognized by the server as being outside the scope of operation of the application.

In the exemplary examples discussed in the foregoing, the server, or a general computing device, may generate and store classification information that relates to information and behavioral data gathered about applications used by mobile communication devices. In an embodiment, one or more of the mobile communication device and the network and structure stores classifications for known good applications and known bad applications. These classifications associated with various applications may be used by the server and/or the mobile communication device as part of the decision-making process for determining if an application should be executed or the allowed to continue to execute on a mobile communication device.

In an embodiment, determinations and classifications associated with applications and cached on a device are may only be considered valid for a period of time so that the mobile communication device does not rely on data that is potentially out of date. In an embodiment, cached determinations and classifications are stored indefinitely and considered to be valid without time constraint. In an embodiment, a device only stores certain types of determinations and classifications. For example, a device may only cache known good determinations or may only cache known bad determinations. In this case, classifications are only stored if they have a corresponding determination. In an embodiment, part of the cache is stored in volatile storage, such as RAM, and part of the cache is stored on non-volatile memory, such as flash. Because volatile memory is typically more limited yet much faster than non-volatile memory, a device may store frequently accessed determinations and classifications in volatile memory while less frequently accessed determinations and classifications in non-volatile memory. For example, if an anti-malware system analyzes data objects every time they are opened, it may be desirable to very quickly determine an determination for a data object if it has been recently scanned and not changed. By storing a recently used classification and determination in volatile memory, the device can recall the previous determination very quickly.

In an embodiment, software on the mobile communication device may display a user interface dialog when it receives a request to transmit application data for an application, such as its content or behavioral data. A request for the application's content may be for the whole content or for a portion of the content, the request identifying which portion of the content if a portion is requested. The user interface dialog displayed may identify the application for which application data is to be transmitted, and give the device's user a chance to allow or reject the transmission. In an embodiment, the dialog allows the user to have the device remember his or her decision for future applications. In an embodiment, the dialog allows the user to view more in-depth information about the application data to be sent, and provides a way for the user to understand the privacy implications of sending the data such as linking to a privacy policy, privacy description, or other content that describes how the data is transmitted, stored, and used. In an embodiment, a mobile communication device may attempt to transmit data associated with an application when it receives an indication server needs more information to produce a determination. In an embodiment, some attempted transmission of certain types of application data may result in a user interface dialog for confirmation, while other types of application data, such as metadata or behavioral data, are transmitted without requiring a user confirmation.

In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The exemplary processes discussed herein may be implemented with hardware, software, firmware, or any combination thereof. In the context of software/firmware, instructions stored on one or more processor-readable storage media that, when executed by one or more processors, may perform the recited operations. The operations of the exemplary processes may be rendered in virtually any programming language or environment including (by way of example and not limitation): C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

Processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

What is claimed:

1. A method, comprising:
receiving data at a server, the data identifying at least a portion of an application accessible by a mobile communication device;
determining if classification information for the application corresponds to the data, the classification information stored in a storage accessible by the server, the storage storing a corresponding determination for the classification information;
if classification information corresponds to the data, the server providing the determination corresponding to the classification information.

2. The method of claim 1, further comprising: before receiving data at the server computer, determining if classification information stored in a storage at the mobile communication device corresponds to the data, the storage storing a corresponding determination for the classification information; and, if classification information in the storage at the mobile communication device does not correspond to the data, then receiving at least a portion of the data at the server from the mobile communication device.

3. The method of claim 1, wherein the data is behavioral data associated with the application.

4. The method of claim 1, wherein the data is metadata associated with the application.

5. The method of claim 1, wherein the classification information includes a package name associated with the application.

6. The method of claim 1, further comprising: if the data does not correspond to classification information stored in the storage, then analyzing, by the server, at least a portion of the data to determine an classification; and, storing the classification in the storage.

7. The method of claim 1, further comprising preventing the mobile communication device from accessing the application.

8. The method of claim 1, further comprising transmitting a notification to the mobile communication device.

9. The method of claim 8, wherein the notification is a warning.

10. The method of claim 8, wherein the notification is an instruction to uninstall the application.

11. A method, comprising:
determining, by a mobile communication device, if classification information in a storage corresponds to an application accessible by the mobile communication device;
if the classification information in the storage does not correspond to the application, then receiving data pertaining to the application at a server computer;
determining, by the server, if classification information for an application corresponds to the received data, the classification information stored in storage accessible by the server, the storage accessible by the server storing a corresponding determination for the classification information; and
if classification information corresponds to the received data, then the server transmitting the determination corresponding to the classification information.

12. The method of claim 11, wherein the data is behavioral data associated with the application.

13. The method of claim 11, wherein the data is metadata associated with the application.

14. The method of claim 11, further comprising: if the classification information does not correspond to the received data, then determining, by the server, a determination for the application using the received data.

15. The method of claim 11, further comprising: requesting, by the server, additional data pertaining to the application accessible by the mobile communication device; and, analyzing the additional data.

16. The method of claim 11, further comprising preventing the mobile communication device from accessing the application.

17. The method of claim 11, further comprising transmitting a notification to the mobile communication device.

18. The method of claim 17, wherein the notification is a warning.

19. The method of claim 17, wherein the notification is an instruction to uninstall the application.

20. The method of claim 17, wherein the notification is an instruction preventing the mobile communication device from accessing the application.
